(19) United States
(12) Patent Application Publication
(10) Pub. No.: US 2023/0308893 A1
(43) Pub. Date: Sep. 28, 2023

(54) CONTROL SYSTEM, CONTROL APPARATUS, CONTROL METHOD AND CONTROL PROGRAM

(71) Applicant: NIPPON TELEGRAPH AND TELEPHONE CORPORATION, Tokyo (JP)

(72) Inventors: Daisuke MURAYAMA, Tokyo (JP); Shota NAKAYAMA, Tokyo (JP); Kenichi KAWAMURA, Tokyo (JP)

(21) Appl. No.: 18/040,451

(22) PCT Filed: Aug. 21, 2020
(86) PCT No.: PCT/JP2020/031725

§ 371 Date: Feb. 3, 2023

(51) Int. Cl. H04W 16/28

(52) U.S. Cl. CPC H04W 16/28

(57) ABSTRACT

A control system includes a base station and a control apparatus for controlling the base station. The control apparatus includes a processor, and a memory that includes instructions, which when executed, cause the processor to identify an area having a line-of-sight relationship in a communication area of the base station for each parameter for determining a transmission point and a transmission direction of a radio wave transmitted from the base station, and calculate an index value regarding the identified area; and control a transmission point and a transmission direction of a radio wave transmitted from the base station by using a parameter in which the index value becomes maximum.

### TECHNICAL FIELD

The present invention relates to a control system, a control apparatus, a control method, and a program.

### BACKGROUND ART

In the 5th generation mobile communication system (5G), a high frequency band called a millimeter wave band is used in addition to the conventional frequency band. In general, since a radio wave in a high frequency band has a large distance attenuation, for example, in the following NPL 1, long-distance transmission is realized by using a beam forming transmission technique with an ultra-high gain.

### CITATION LIST

### Non Patent Literature

[NPL 1] Yoshihisa Kishiyama, et al., “5G outdoor experiment of ultra-high speed and long distance transmission using millimeter waves”, NTT DOCOMO Technical Journal Vol. 26 No. 1, April 2018

### SUMMARY OF INVENTION

### Technical Problem

On the other hand, the radio wave in the high frequency band is easily affected by a shield in a communication area because the radio wave has high linearity and large attenuation due to a shield.

An object of the present disclosure is to form the communication area corresponding to the shield.

### Solution to Problem

According to an aspect of the present disclosure, a control system comprising a base station and a control apparatus for controlling the base station including:
a calculation unit that specifies an area having a line-of-sight relationship in a communication area of the base station for each parameter for determining a transmission point and a transmission direction of the radio wave of the base station, and calculates an index value regarding to the specified area, and
a control unit that controls a transmission point and a transmission direction of a radio wave of the base station by using a parameter in which the index value becomes maximum.

### Advantageous Effects of Invention

According to the present disclosure, the communication area corresponding to the shield can be formed.

### BRIEF DESCRIPTION OF DRAWINGS

FIG. 1 is a diagram showing a system configuration example of a control system.

FIG. 2 is a first diagram showing an outline of a movable example of a base station and an area in a line-of-sight relationship.

FIG. 3 is a diagram showing an example of an index value data.

FIG. 4 is a diagram showing an example of a hardware configuration of a control apparatus.

FIG. 5 is a first diagram showing an example of a functional configuration of a base station position attitude control unit.

FIG. 6 is a first flowchart showing a flow of a base station position attitude control process.

FIG. 7 is a second diagram showing a system configuration example of a control system.

FIG. 8 is a second diagram showing the outline of the movable example of the base station and the area in the line-of-sight relationship.

FIG. 9 is a second diagram showing an example of the index value data.

FIG. 10 is a second diagram showing an example of a functional configuration of the base station position attitude control unit.

FIG. 11 is a second flowchart showing a flow of the base station position attitude control process.

FIG. 12 is a third diagram showing a system configuration example of the control system.

FIG. 13 is a third diagram showing the outline of the movable example of the base station and the area in the line-of-sight relationship.

FIG. 14 is a third diagram showing an example of the index value data.

FIG. 15 is a third diagram showing an example of a functional configuration of the base station position attitude control unit.

FIG. 16 is a third flowchart showing a flow of the base station position attitude control process.

### DESCRIPTION OF EMBODIMENTS

Hereinafter, each embodiment will be described with reference to the attached drawings. In the present specification and the drawings, components having substantially the same functional configuration are designated by the same reference signs, and duplicate description will be omitted.

### First Embodiment

### System Configuration of Control System

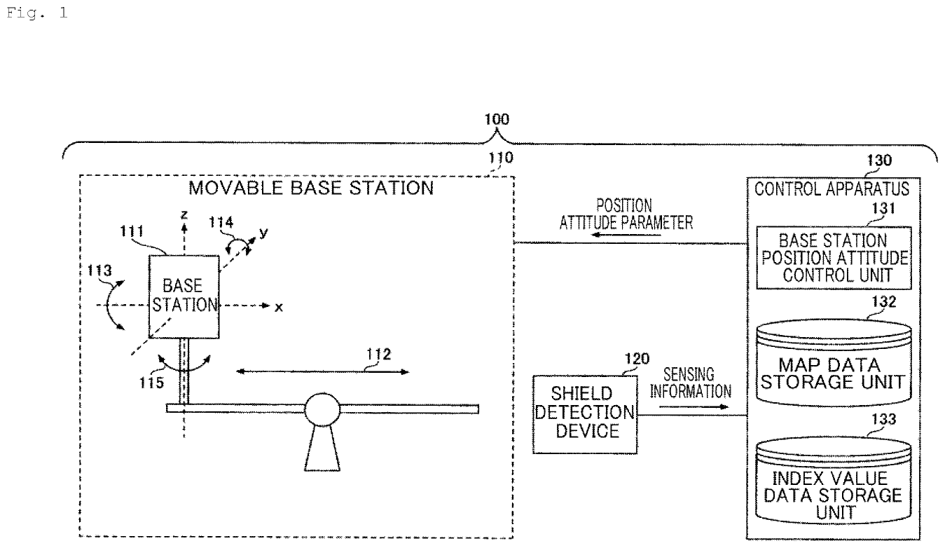

First, a system configuration of an entire control system according to a first embodiment will be described. FIG. 1 is a first diagram showing an example of a system configuration of a control system. As shown in FIG. 1, the control system 100 includes a movable base station 110, a shield detection device 120, and a control apparatus 130. The movable base station 110 and the control apparatus 130 are communicably connected by wire or radio. Similarly, the shield detection device 120 and the control apparatus 130 are communicably connected by wire or wirelessly.

The movable base station 110 has a base station 111. The base station 111 realizes high-speed, large-capacity communication with a terminal (not shown) by transmitting and receiving high-frequency band radio waves used in, for example, a fifth-generation mobile communication system (5G).

The movable base station 110 has a movable structure for supporting the base station 111. The movable structure linearly moves the base station 111 in the direction of the arrow 112, based on a position attitude parameter transmitted from the control apparatus 130, for example. Further, the movable structure may, for example, rotate the base station 111 around the x-axis (see reference sign 113), around the y-axis (see reference sign 114), and around the z-axis (see reference sign 115) based on the position attitude parameter transmitted from the control apparatus 130. Thus, in the movable base station 110, a transmission point and a transmission direction of the radio wave of the base station 111 are controlled.

In this embodiment, an intersection position of the x-axis, y-axis, and z-axis shown in FIG. 1 is set as the origin of the position coordinates in the movable base station 110.

In the movable base station 110 shown in FIG. 1, the position and attitude of the base station 111 are physically moved to control the transmission point and the transmission direction of the radio wave of the base station 111. However, when the movable base station 110 is constructed by, for example, a distributed antenna system, the transmission point and the transmission direction of the radio waves of the base station may be controlled by controlling the output of each unit.

In this case, the movable base station 110 controls the output of each unit of the distributed antenna system on the basis of the Enable/Disable signal transmitted from the control apparatus 130, thereby controlling the transmission point and the transmission direction of the radio wave of the base station.

In other words, the parameters for determining the transmission point and transmission direction of the radio wave of the base station may include an Enable/Disable signal, for example, in addition to the position attitude parameter. In the following, a case will be described in which the position and attitude of the base station 111 are physically moved to control the transmission point and transmission direction of the radio wave of the base station.

The shield detection device 120 has an imaging device for detecting a shield in a communication area or a LIDAR (Laser Imaging Detection and Ranging) device. The shield detection device 120 transmits sensing information such as video information photographed by the imaging device or LIDAR information measured by the LIDAR device to the control apparatus 130.

A base station position attitude control program is installed in the control apparatus 130, and the control apparatus 130 functions as a base station position attitude control unit 131 by executing the program.

The base station position attitude control unit 131 generates two-dimensional or three-dimensional map data (shield map) in a communication area formed by the base station 111 in real time on the basis of sensing information transmitted from the shield detection device 120, and stores the shield map in the map data storage unit 132. The shield map is a map indicating the position and size of the shield in the communication area.

Further, the base station position attitude control unit 131 specifies an area having a line-of-sight relationship for each predetermined position attitude parameter, and calculates the area (index value) of the specified area based on the shield map. Further, the base station position attitude control unit 131 stores the area of the specified area in an index value data storage unit 133 as an index value data in association with the position attitude parameter.

Further, the base station position attitude control unit 131 selects a position attitude parameter having the maximum area among the area (index values) of the areas in the line-of-sight relationship calculated for each position attitude parameter, and transmits it to the movable base station 110.

Thus, the movable base station 110 can control the position and attitude of the base station 111 so that the area of the area in the line-of-sight relationship is maximum, that is, the area of the area shielded by the shield is minimum. As a result, the control system 100 can form the communication area corresponding to the shield.

### Examples of Base Station Movement and Areas in Line-of-Sight Relationships

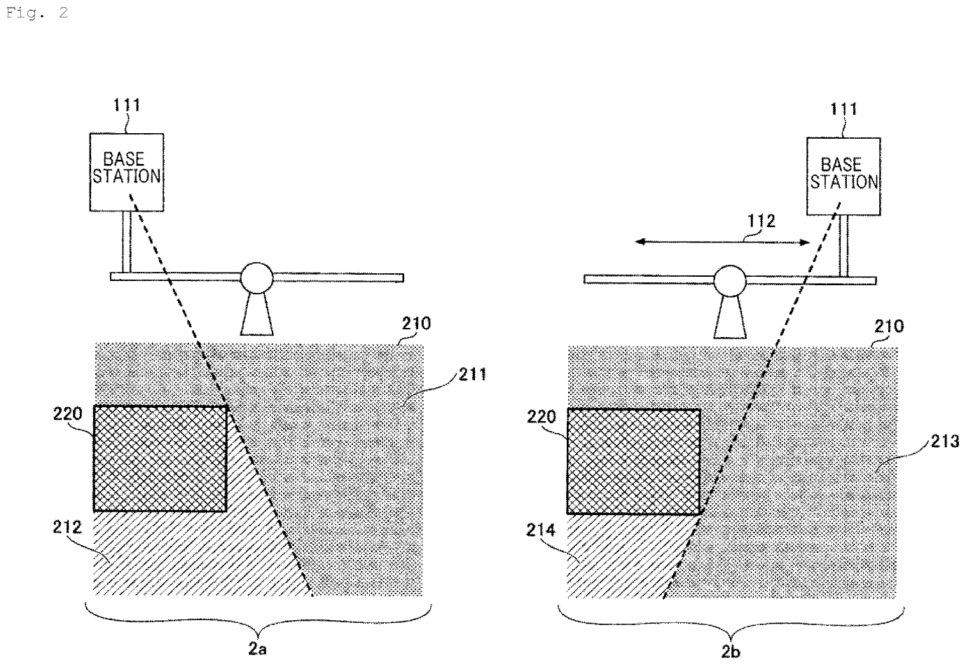

Next, a movable example of the base station 111 and an area in the line-of-sight relationship will be described. FIG. 2 is a first diagram showing an outline of the movable example of a base station and an area in a line-of-sight relationship. Note that FIG. 2 shows an example in which two-dimensional map data 210 (shield map) in which only one shield 220 exists in the communication area is generated.

Of these, 2a in FIG. 2 shows a state in which the position and attitude of the base station 111 are controlled based on the first position attitude parameter to form the communication area. In the example of 2a of FIG. 2, among the communication areas shown in the two-dimensional map data 210 (shield map),
the area indicated by reference sign 211 is in the line-of-sight relationship,
and the area indicated by reference sign 212 is not in the line-of-sight relationship
by being shielded by the shield 220.

On the other hand, 2b in FIG. 2 shows how the position and attitude of the base station 111 are controlled based on the second position attitude parameter to form the communication area (specifically, 2b in FIG. 2 shows linear movement along the x-axis along the arrow 112 and rotation around the z-axis of the base station 111). In the example of 2b of FIG. 2, among the communication areas shown in the two-dimensional map data 210 (shield map),
the area indicated by reference sign 213 is in the line-of-sight relationship,
and the area indicated by reference sign 214 is not in the line-of-sight relationship by being shielded by the shield 220.

In this way, the area of the area in the line-of-sight relationship varies even in the same communication area by the position attitude parameter transmitted from the base station position attitude control unit 131. Therefore, the base station position attitude control unit 131 selects a position attitude parameter in which the area of the area in the line-of-sight relationship becomes maximum, as described above.

### Explanation of Index Value Data

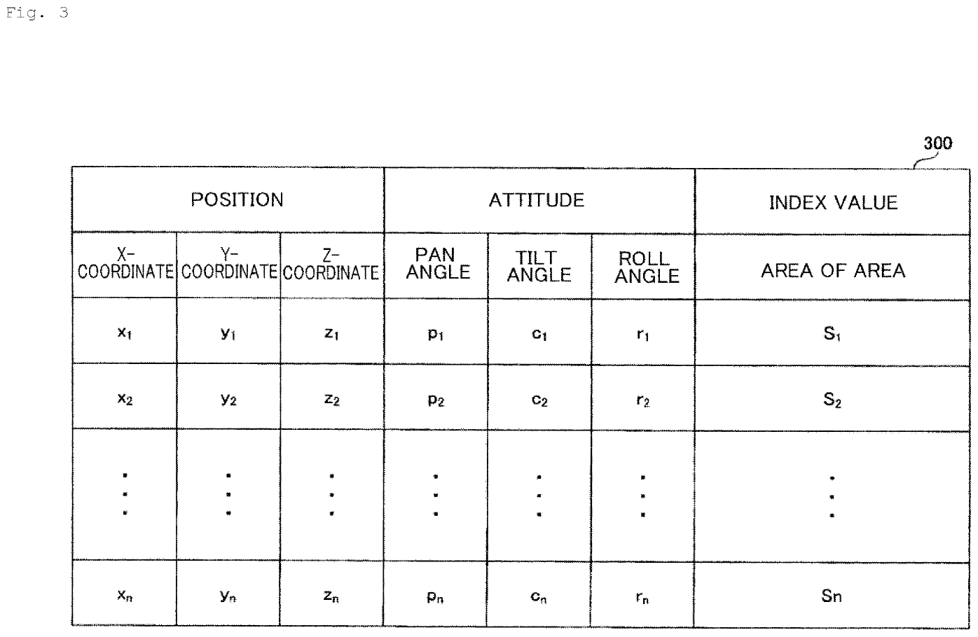

Next, the index value data stored in the index value data storage unit 133 will be described. FIG. 3 is a first diagram showing an example of the index value data. As shown in FIG. 3, an index value data 300 has a “position”, an “attitude”, and an “index value” as information items.

Of these, the “position” further includes “x-coordinate”, “y-coordinate”, and “z-coordinate” as information items. The x-coordinate, the y-coordinate, and the z-coordinate indicating the position of the base station 111 are stored in the “x-coordinate”, the “y-coordinate”, and the “z-coordinate”, respectively.

Further, the “attitude” further includes “pan angle”, “tilt angle”, and “roll angle” as information items. The pan angle, tilt angle, and roll angle indicating the attitude of the base station 111 are stored in the “pan angle”, the “tilt angle”, and the “roll angle”, respectively.

Further, the “index value” refers to an “area of an area” in the present embodiment. An area in the line-of-sight relationship, which the base station position attitude control unit 131 calculates based on the shield map, and the combination of the corresponding position attitude parameters of “position” and “attitude”, is stored in the “area of an area”.

In the example of FIG. 3, in the case of a combination of each position attitude parameter of x-coordinate=x₁, y-coordinate=y₁, z-coordinate=z₁, pan angle=p₁, tilt angle=c₁, and roll angle=r₁ shows that area of an area=S₁ is calculated. In this way, the base station position attitude control unit 131 calculates area of an area for combinations of predetermined position attitude parameters each time the shield map is generated.

### Hardware Configuration of Control Apparatus

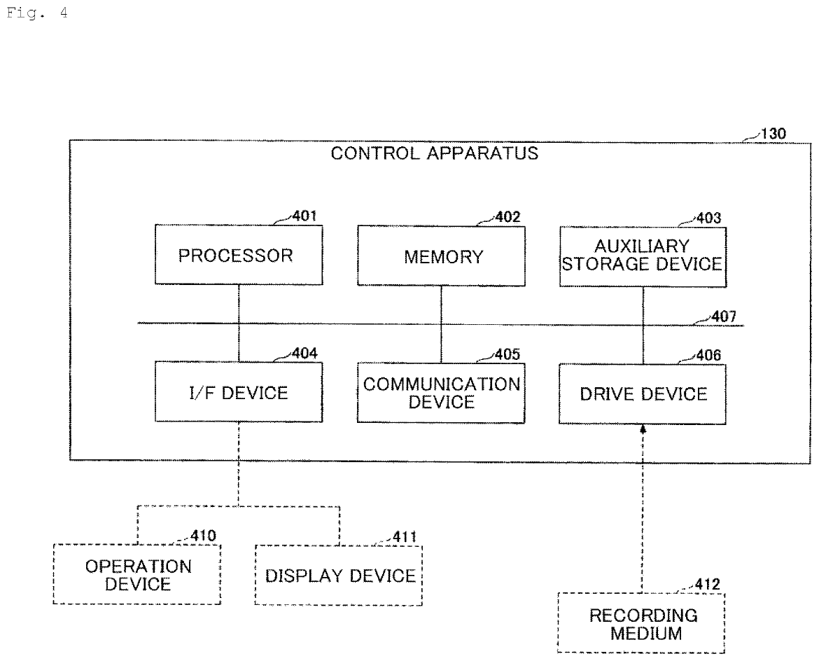

Next, the hardware configuration of the control apparatus 130 will be described. FIG. 4 is a diagram showing a hardware configuration example of the control apparatus. As shown in FIG. 4, the control apparatus 130 includes a processor 401, a memory 402, an auxiliary storage device 403, an I/F (interface) device 404, a communication device 405, and a drive device 406. The hardware of the control apparatus 130 is connected to each other via a bus 407.

The processor 401 is, for example, various arithmetic operation devices such as a central processing unit (CPU) and a graphics processing unit (GPU). The processor 401 reads various programs (for example, the base station position attitude control program, and the like) onto the memory 402 and executes them.

The memory 402 has a main storage device such as a ROM (Read Only Memory) and a RAM (Random Access Memory). The processor 401 and the memory 402 form a so-called computer, and the processor 401 executes various programs read out from the memory 402, thereby realizing various functions.

The auxiliary storage device 403 stores various programs and various data used when the various programs are executed by the processor 401. For example, the map data storage unit 132 and the index value data storage unit 133 are realized in the auxiliary storage device 403.

An I/F device 404 is a connection device for connecting an operation device 410, a display device 411, and the control apparatus 130, which are examples of external devices. The I/F device 404 receives an operation to the control apparatus 130 via the operation device 410. Further, the I/F device 404 outputs the result of processing by the controller 130 and displays the result on the display device 411.

The communication device 405 is a communication device for communicating with another device (for example, the movable base station 110 and the shield detection device 120) via a network.

The drive device 406 is a device for setting a recording medium 412. The recording medium 412 includes a medium for optically, electrically or magnetically recording information, such as a CD-ROM, a flexible disk, a magneto-optical disk, and the like. The recording medium 412 may include a semiconductor memory for electrically recording information such as a ROM or a flash memory.

Various programs to be installed in the auxiliary storage device 403 are installed, for example, by setting the distributed recording medium 412 in the drive device 406 and reading the various programs recorded in the recording medium 412 by the drive device 406. Alternatively, various programs installed in the auxiliary storage device 403 may be installed by being downloaded from the network via the communication device 405.

### Functional Configuration of Base Station Position Attitude Control Unit

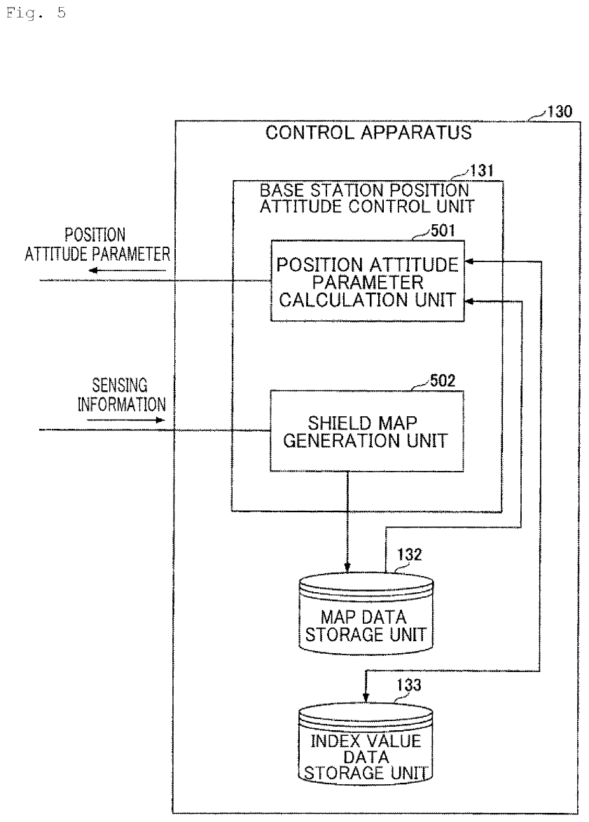

Next, the functional configuration of the base station position attitude control unit 131 of the control apparatus 130 will be described in detail with reference to FIGS. 2 and 3. FIG. 5 is a first diagram showing an example of the functional configuration of the base station position attitude control unit. As shown in FIG. 5, the base station position attitude control unit 131 includes a position attitude parameter calculation unit 501 and a shield map generation unit 502.

The shield map generation unit 502 is an example of a generation unit, and generates a two-dimensional or three-dimensional map data (shield map) in the communication area formed by the base station 111 in real time on the basis of sensing information transmitted from the shield detection device 120. Further, the shield map generation unit 502 stores the generated shield map in the map data storage unit 132.

Specifically, the shield map generation unit 502 calculates the position and size of the shield 220 on the basis of, for example, video information transmitted from the shield detection device 120, and generates the two-dimensional map data 210 (shield map) in real time. In the example shown in FIG. 2, the shield 220 is a fixed object, but the shield 220 may be a moving object. Therefore, in the shield map generation unit 502, the two-dimensional or three-dimensional map data (shield map) stored in the map data storage unit 132 is updated at a predetermined cycle.

The position attitude parameter calculation unit 501 is an example of a calculation unit and a control unit, and calculates an area of an area having the line-of-sight relationship in the communication area for each predetermined position attitude parameter on the basis of the shield map. Further, the position attitude parameter calculation unit 501 associates the calculated area of area with the position attitude parameter, and stores as the index value data in the index value data storage unit 133. Further, the position attitude parameter calculation unit 501 selects the position attitude parameter having the largest area among area of an area for each position attitude parameter stored as the index value data, and transmits the position attitude parameter to the movable base station 110.

Specifically, the position attitude parameter calculation unit 501 reads out, for example, a two-dimensional map data 210 (shield map) from the map data storage unit 132. Further, the position attitude parameter calculation unit 501 is calculated area of an area in the line-of-sight relationship based on the two-dimensional map data 210 for each combination of the position attitude parameters from the x coordinate to the roll angle included in the “position” and “posture” of the index value data 300. The position attitude parameter calculation unit 501 stores area of an area calculated for each combination of the position attitude parameters in index value data 300. Further, the position attitude parameter calculation unit 501 selects a combination of position attitude parameters to be the maximum area (from the x-coordinate to the roll angle) in an area of the area for each combination of position attitude parameters stored in the index value data 300, and transmits it to the movable base station 110. Thus, the base station position attitude control unit 131 can control the position and attitude of the base station 111 of the movable base station 110 according to the shield.

### Flow of Base Station Position Attitude Control Process

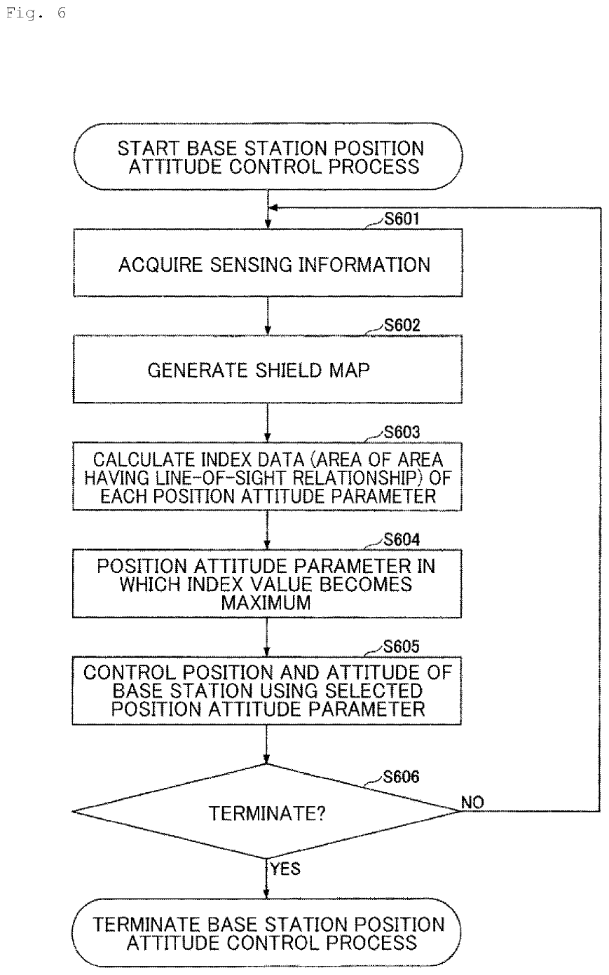

Next, the flow of the base station position attitude control process by the base station position attitude control unit 131 of the control apparatus 130 will be described. FIG. 6 is a first flowchart showing the base station position attitude control process.
In step S601, the shield map generation unit 502 acquires sensing information from the shield detection device 120.
In step S602, the shield map generation unit 502 generates a shield map on the basis of the acquired sensing information, and stores it in the map data storage unit 132.
In step S603, the position attitude parameter calculation unit 501 calculates an area of the area having a line-of-sight relationship on the basis of the shield map for each combination of the position attitude parameters, as the index value data, and stores in the index value data storage unit 133.
In step S604, the position attitude parameter calculation unit 501 selects a combination of the position attitude parameters in which an area of the area in the line-of-sight relationship becomes maximum from among combinations of the respective position attitude parameters.
In step S605, the position attitude parameter calculation unit 501 transmits the combination of the selected the position attitude parameters to the movable base station 110 to control the position and attitude of the base station 111.
In step S606, the position attitude parameter calculation unit 501 determines whether or not terminates the base station position attitude control process. When it is determined that the base station position attitude control process is continued in step S606 (if NO in step S606), the process returns to step S601. Thus, the position attitude parameter calculation unit 501 can control the position and attitude of the base station 111 at every predetermined period.
On the other hand, when it is determined that the base station position attitude control process is terminated in step S606 (if YES in step S606), the base station position attitude control process is terminated.

### Summary

As is clear from the above description, the control system 100 according to the first embodiment;
includes the base station and the control device for controlling the base station,
for each combination of parameters that determine the transmission point and transmission direction of the radio wave of the base station, specifies the area having the line-of-sight relationship (area not shielded by the shield) in the communication area of the base station, calculates the area of the specified area (index value),
controls the transmission point and transmission direction of the radio wave of the base station by using the combination of parameters that maximizes the calculated the area of an area.

Thus, the control system 100 according to the first embodiment can form a communication area corresponding to the shield. As a result, for example, when there is a possibility that there are many terminals that have not been detected depending on the communication area formed by the base station, the first embodiment can improve the overall communication quality.

### Second Embodiment

In the first embodiment, it has been described that the case that the combination of position attitude parameters is selected using the area of an area of the area in a line-of-sight relationship as an index value. However, the index value for selecting the combination of position attitude parameters is not limited to this, and for example, the number of terminals located in the area having the line-of-sight relationship may be used as the index value. For a second embodiment, the differences from the first embodiment will be mainly described.

### System Configuration of Control System

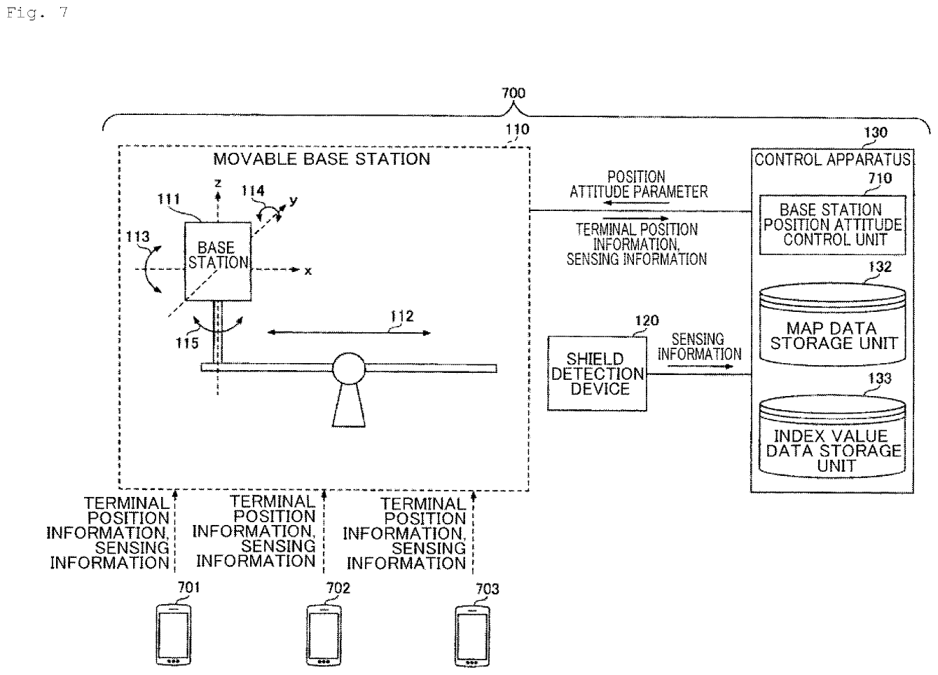

First, a system configuration of the entire control system according to the second embodiment will be described. FIG. 7 is a second diagram showing an example of the system configuration of the control system. The difference between a control system 700 shown in FIG. 7 and the control system 100 described with reference to FIG. 1 in the first embodiment is that terminals 701, 702 and 703 are included in the control system 700, and a function of a base station position attitude control unit 710 is different from a function of a base station position attitude control unit 131.

Each of the terminals 701 to 703 transmits a terminal position information indicating a position of the own terminal (for example, GPS (Global Positioning System) information or information detected by another position detection technology) via a movable base station 110 to a control apparatus 130. Each of the terminals 701 to 703 transmits the terminal position information using, for example, an upstream data channel (or a control channel).

Further, each of the terminals 701 to 703 detects a shield around the terminal, and transmits a sensing information (video information or LIDAR information) the control apparatus 130 via the movable base station 110. Each of the terminals 701 to 703 transmits sensing information using, for example, an upstream data channel (or a control channel).

Although only three terminals are shown in the example of FIG. 7 for convenience of explanation, the number of terminals included in the control system 700 is not limited to three, but may be less than three or four or more.

The base station position attitude control unit 710 of the control apparatus 130 generates a shield map in a communication area formed by a base station 111 in real time on the basis of the sensing information transmitted from a shield detection device 120 and the sensing information transmitted from the terminals 701 to 703.

The base station position attitude control unit 710 calculates, for each predetermined position attitude parameter, the number of terminals located in an area having a line-of-sight relationship (an index value) on the basis of the shield map and the terminal position information. Further, the base station position attitude control unit 710 stores the calculated number of terminals in an index value data storage unit 133 as index value data in association with the position attitude parameter.

Further, the base station position attitude control unit 710 selects the position attitude parameter having the maximum the number of terminals among the number of terminals (index values) of the area having the line-of-sight relationship calculated for each position attitude parameter, and transmits it to the movable base station 110.

Thus, the movable base station 110 can control the position and attitude of the base station 111 so that the number of terminals located in the area having the line-of-sight relationship is maximum, that is, the number of terminals located in a shielded area is minimum. As a result, the control system 700 can form the communication area corresponding to the shield and the terminal position.

### Movable Example of Base Station, and Area in Line-of-Sight Relationship

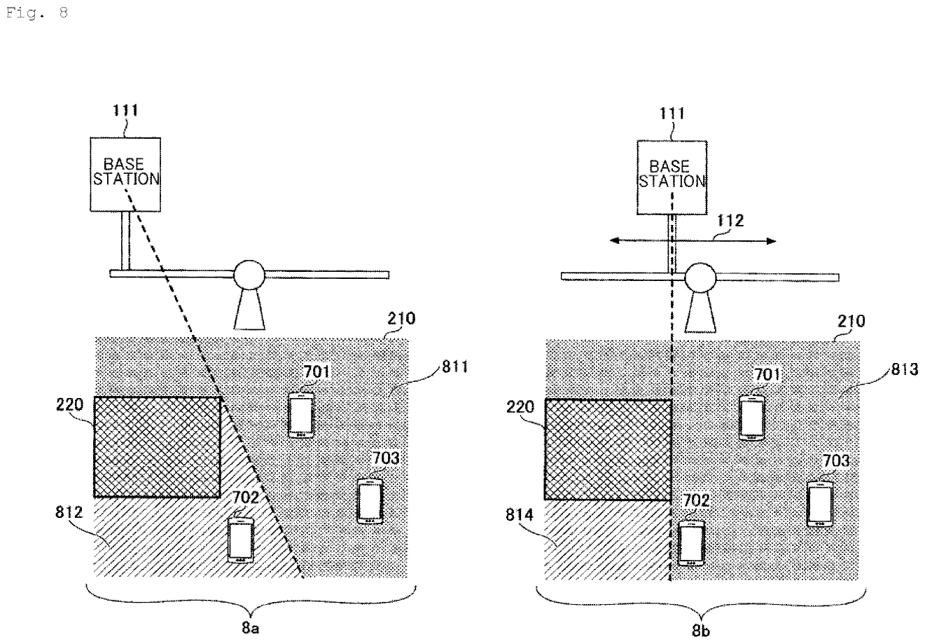

Next, a movable example of the base station 111 and the area in the line-of-sight relationship will be described. FIG. 8 is a second diagram showing an outline of a movable example of the base station and an area in the line-of-sight relationship. FIG. 8 shows an example in which a two-dimensional map data 210 (shield map) having only one shield 220 in the communication area is generated.

Of these, 8a of FIG. 8 shows a state in which the position and attitude of the base station 111 are controlled based on the first position attitude parameter to form a communication area. In the example of 8b of FIG. 8, among the communication areas shown in the two-dimensional map data 210 (shield map),
terminals 701 and 703 located in the area indicated by reference sign 811 is in the line-of-sight relationship,
and terminal 702 located in the area indicated by reference sign 812 is not in the line-of-sight relationship
by being shielded by the shield 220.

On the other hand, 8b in FIG. 8 shows how the position and attitude of the base station 111 are controlled based on the second position attitude parameter to form a communication area (specifically, 2b in FIG. 2 shows linear movement along the x-axis along the arrow 112 and rotation around the z-axis of the base station 111). In the example of 8b of FIG. 8, among the communication areas shown in the two-dimensional map data 210 (shield map),
the terminal 701 to 703 located in the area indicated by reference sign 813 is in the line-of-sight relationship,
and there is no terminal located in the area indicated by reference sign 814 having the line-of-sight relationship.

In this manner, the number of terminals located in the area having the line-of-sight relationship varies even in the same communication area by the position attitude parameter transmitted from the base station position attitude control unit 710. Therefore, the base station position attitude control unit 710 selects a position attitude parameter in which the number of terminals located in the area having the line-of-sight relationship becomes maximum, as described above.

### Explanation of Index Value Data

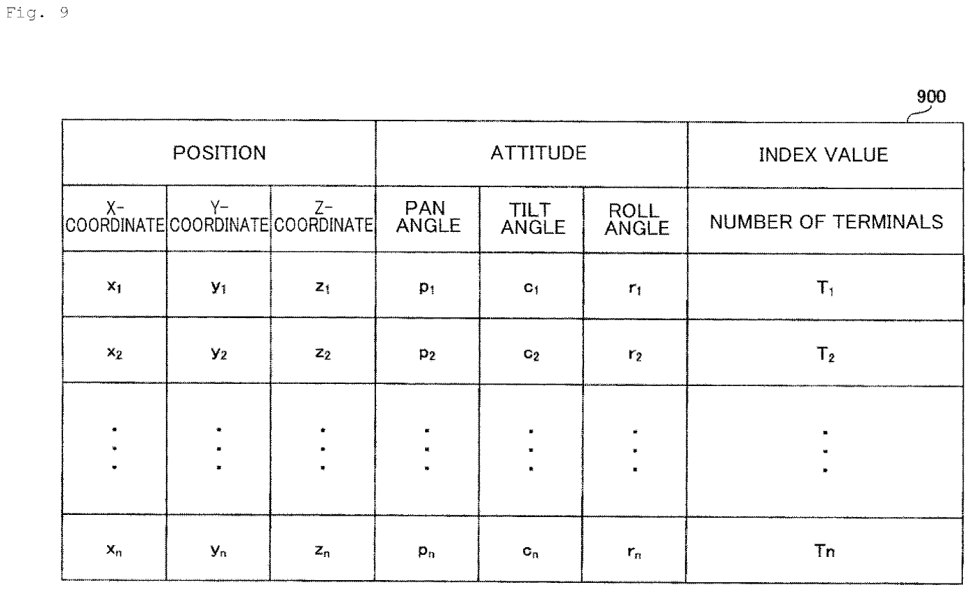

Next, the index value data stored in the index value data storage unit 133 will be described. FIG. 9 is a second diagram showing an example of the index value data. The difference between an index value data 300 described with reference to FIG. 3 in the first embodiment and the index value data 900 is that, in the case of the index value data 900, the “index value” indicates “the number of terminals” instead of “an area of the area”. Further, the number of terminals located in the area having the line-of-sight relationship calculated by the base station position attitude control unit 710 based on the combination of the corresponding position attitude parameters of “position” and “attitude” is stored to the “number of terminals”.

In the example of FIG. 9, in the case of a combination of each position attitude parameter of x-coordinate=x₁, y-coordinate=y₁, z-coordinate=z₁, pan angle=p₁, tilt angle=c₁, and roll angle=r₁ shows that the number of terminals=T₁ is calculated.

In this way, the base station position attitude control unit 710 calculates the number of terminals located in the area having the line-of-sight relationship for combinations of predetermined position attitude parameters each time the shield map is generated.

### Functional Configuration of Base Station Position Attitude Control Unit

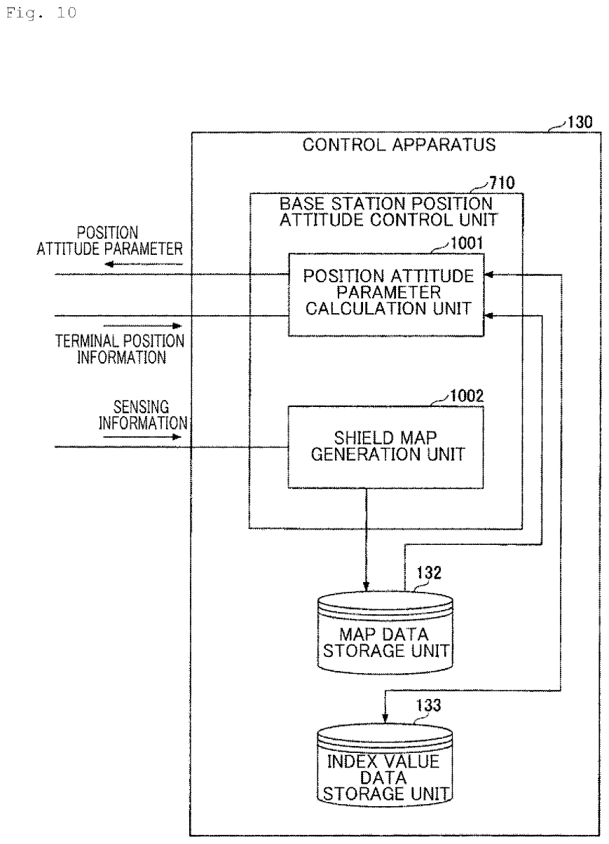

Next, details of the functional configuration of the base station position attitude control unit 710 of the control apparatus 130 will be described with reference to FIGS. 8 and 9. FIG. 10 is a second diagram showing an example of the functional configuration of the base station position attitude control unit. As in the first embodiment, the base station position attitude control unit 710 includes an example of a position attitude parameter calculation unit 1001 (an example of the calculation unit and the control unit), and a shield map generation unit 1002 (an example of generation unit).

However, the shield map generation unit 1002 generates the shield map (for example, two-dimensional map data 210 shown in FIG. 8) based on the sensing information transmitted from the shield detection device 120 and the sensing information transmitted from the terminals 701 to 703.

Further, the position attitude parameter calculation unit 1001 identifies an area having the line-of-sight relationship for each predetermined position attitude parameter, and determines the number of terminals located in the specified area based on the terminal position information and the shield map, and calculates (see, for example, 8a and 8b in FIG. 8). Further, the position attitude parameter calculation unit 1001 stores the calculated number of terminals in the index value data storage unit 133 as index value data (for example, the index value data 900 in FIG. 9) in association with the position attitude parameter. Further, the position attitude parameter calculation unit 1001 selects the position attitude parameter having the maximum number of terminals from the number of terminals for each position attitude parameter stored as the index value data, and transmits the position attitude parameter to the movable base station 110. Thereby, according to the base station position attitude control unit 710, the position and attitude of the base station 111 of the movable base station 110 can be controlled according to the shield and the terminal position.

### Flow of Base Station Position Attitude Control Process

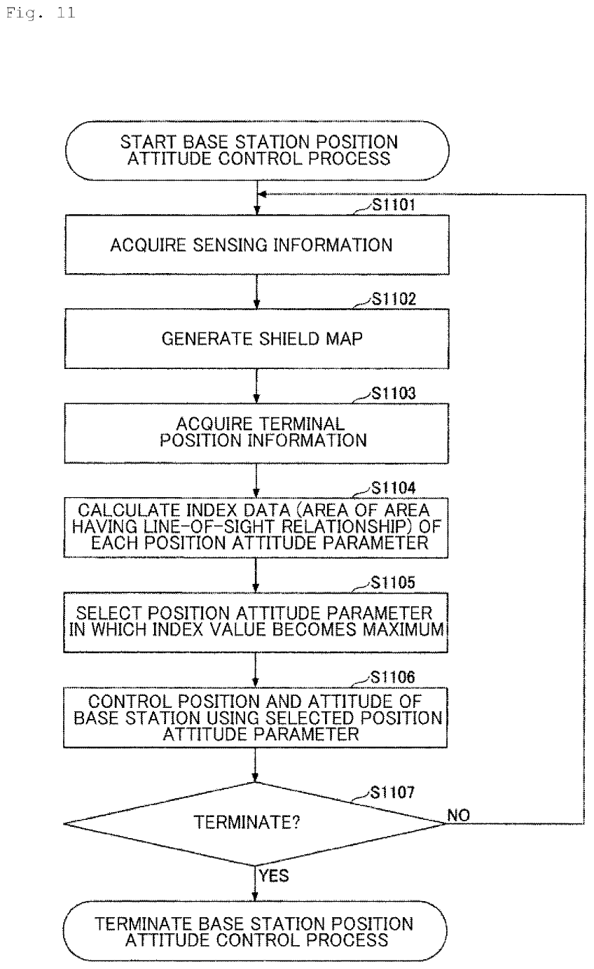

Next, the flow of base station position attitude control process by the base station position attitude control unit 710 of the control apparatus 130 will be described. FIG. 11 is a second flowchart showing the flow of the base station position attitude control process.
In step S1101, the shield map generation unit 1002 acquires sensing information from the shield detection device 120 and terminals 701 to 703.
In step S1102, the shield map generation unit 1002 generates the shield map based on the acquired sensing information and stores it in the map data storage unit 132.
In step S1103, the position attitude parameter calculation unit 1001 acquires the terminal position information from the terminals 701 to 703.
In step S1104, the position attitude parameter calculation unit 1001 calculates the number of terminals located in the area having the line-of-sight relationship based on the shield map and the terminal position information for each combination of the position attitude parameters. Further, the position attitude parameter calculation unit 1001 stores the calculated number of terminals as the index value data in the index value data storage unit 133.
In step S1105, the position attitude parameter calculation unit 1001 selects the combination of the position attitude parameters that maximizes the number of terminals located in the area having the line-of-sight relationship from the combinations of the position attitude parameters.
In step S1106, the position attitude parameter calculation unit 1001 controls the position and attitude of the base station 111 by transmitting the selected combination of position attitude parameters to the movable base station 110.
In step S1107, the position attitude parameter calculation unit 1001 determines whether or not to terminate the base station position attitude control process. If it is determined in step S1107 that the base station position attitude control process is to be continued (NO in step S1107), the process returns to step S1101. As a result, the position attitude parameter calculation unit 1001 can control the position and attitude of the base station 111 at predetermined intervals.
On the other hand, if it is determined in step S1107 that the base station position attitude control process is terminated (YES in step S1107), the base station position attitude control process is terminated.

### Summary

As is clear from the above description, the control system 700 according to the second embodiment;
includes the base station and the control device for controlling the base station,
for each combination of parameters that determine the transmission point and transmission direction of the radio wave of the base station, specifies the area having the line-of-sight relationship (area not shielded by the shield) in the communication area of the base station, calculates the number of terminals (index value) located it in the specified area,
controls the transmission point and transmission direction of the radio wave of the base station by using the combination of parameters that maximizes the calculated the number of terminals.

As a result, according to the control system 700 according to the second embodiment, it is possible to form a communication area according to the position of the shield and the terminal. As a result, according to the second embodiment, it is possible to improve the communication quality of, for example, an active terminal.

### Third Embodiment

In the second embodiment described above, the case where the combination of position attitude parameters is selected using the number of terminals located in the area having a line-of-sight relationship as an index value has been described. However, the index value for selecting the combination of the position attitude parameters is not limited to this, and for example, the total value of the traffic amounts of the terminals located in the area having the line-of-sight relationship may be used as the index value. The third embodiment will be described focusing on differences from the first and second embodiments.

### System Configuration of Control System

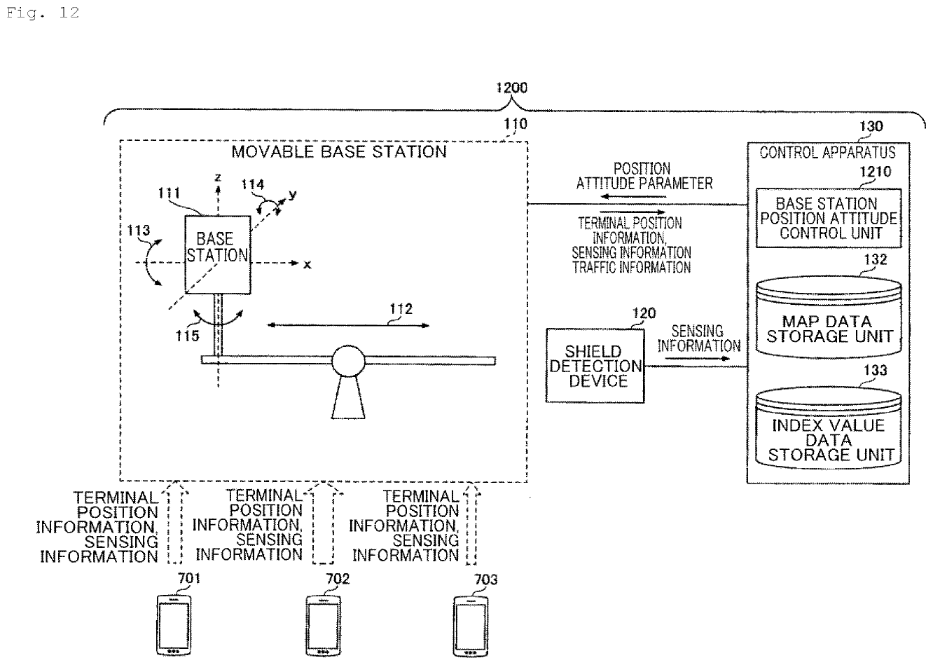

First, the system configuration of the entire control system according to the third embodiment will be described. FIG. 12 is a third diagram showing an example of the system configuration of the control system. The difference between the control system 700 and the control system 700 described with reference to FIG. 7 in the second embodiment is that in the case of a control system 1200 shown in FIG. 12, the function of a base station position attitude control unit 1210 is different from that of the base station position attitude control unit 710.

The base station position attitude control unit 1210 acquires each traffic amount between the terminals 701 to 703 and the base station 111 from the movable base station 110 as traffic information. In FIG. 12, the thickness of the dotted arrow shown between the movable base station 110 and the terminals 701 to 703 indicates the traffic amount. For example, it is assumed that the thinner the dotted arrow indicates the smaller amount of traffic, and the thicker the dotted arrow indicates the larger amount of traffic.

The base station position attitude control unit 1210 calculates the total value (index value) of the total traffic amount of each terminal located in the area having the line-of-sight relationship for each predetermined position attitude parameter based on the shield map, the terminal position information and traffic information. Further, the base station position attitude control unit 1210 stores the calculated total value of the traffic amount in the index value data storage unit 133 as index value data in association with the position attitude parameter.

Further, the base station position attitude control unit 1210 selects the position attitude parameter having the maximum total value from the total values of the traffic amounts calculated for each position attitude parameter, and transmits the position attitude parameter to the movable base station 110.

Thus, the movable base station 110 can control the position and attitude of the base station 111 so that the total value of the traffic amount of each terminal located in the area having the line-of-sight relationship is maximized. As a result, according to the control system 1200, it is possible to form a communication area according to the shield, the terminal position, and the traffic amount.

### Movable Example of Base Station, and Area in Line-of-sight Relationship

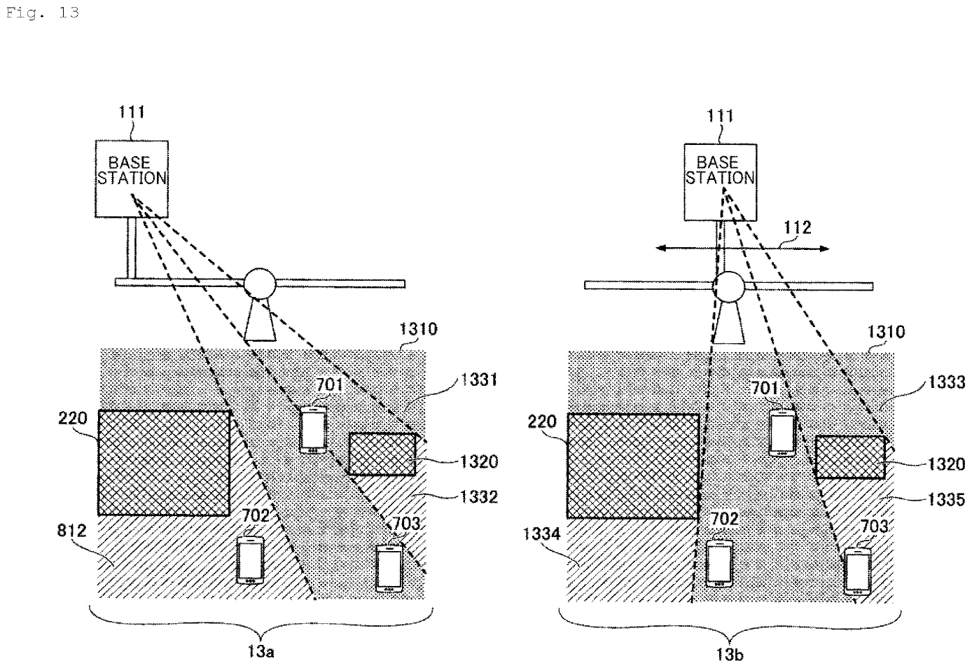

Next, a movable example of base station 111 and an area with line-of-sight relationship will be described. FIG. 13 is a third diagram showing an outline of a movable example of a base station and an area having the line-of-sight relationship. Note that FIG. 13 shows an example in which two-dimensional map data 1310 (shield map) in which two shields (shields 220 and 1320) exist in the communication area is generated.

Of these, 13a in FIG. 13 shows a state in which the position and attitude of the base station 111 are controlled based on the first position attitude parameter to form a communication area. In the example of 13a of FIG. 13, among the communication areas shown in the two-dimensional map data 1310 (shield map),
the terminals 701 and 703 located in the area shown by the reference sign 1331 are in the line-of-sight relationship and have a reference sign.

The terminal 702 located in the area shown in reference sign 812 is shielded by the shield 220,
indicating that there is no line-of-sight relationship.

On the other hand, 13b of FIG. 13 shows how the position and attitude of the base station 111 are controlled based on the second position attitude parameter to form a communication area (specifically, along the arrow 112, and it shows a state in which the base station 111 is directly moved in the x-axis direction and rotated around the z-axis). In the example of 13b in FIG. 13, among the communication areas shown in the two-dimensional map data 1310 (shield map),
terminals 701 and 702 located in the area indicated by reference sign 1333 are in the line-of-sight relationship, and
the terminal 703 located in the area indicated by reference sign 1335 is shielded by the shield 1320, and
is indicated that there is no line-of-sight relationship.

In this way, depending on the position attitude parameter transmitted from the base station position attitude control unit 1210, even if the number of terminals is located in the same communication area and the number of terminals located in the area having the line-of-sight relationship is the same, the total traffic amount fluctuates. This is because the traffic volume of the terminal 702 is not equal to the traffic volume of the terminal 703 in the example shown in FIG. 13. Therefore, as described above, the base station position attitude control unit 1210 selects the position attitude parameter that maximizes the total traffic amount of each terminal located in the area having the line-of-sight relationship.

### Explanation of Index Value Data

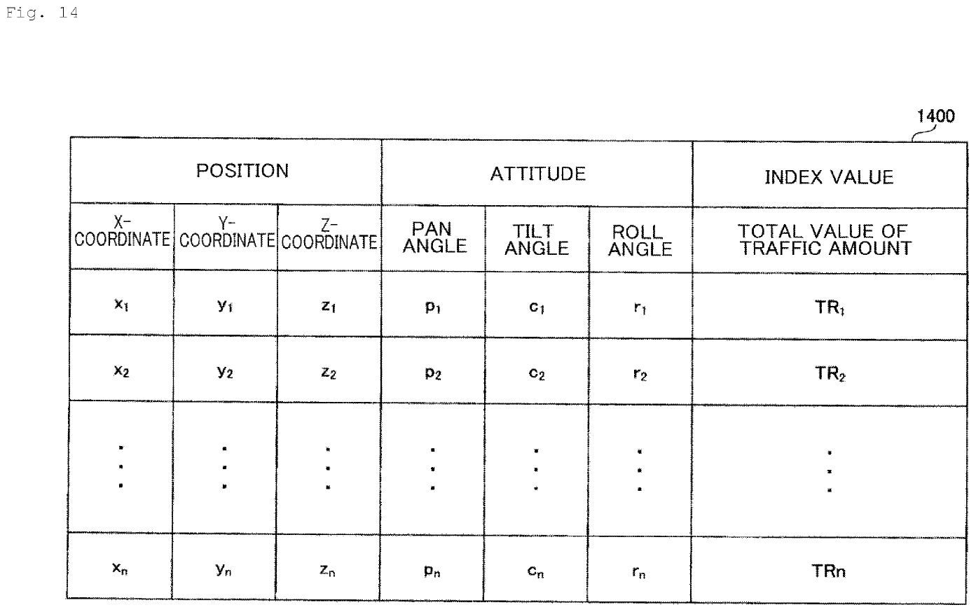

Next, the index value data stored in the index value data storage unit 133 will be described. FIG. 14 is a third diagram showing an example of the index value data. The difference from an index value data 300 described with reference to FIG. 3 in the first embodiment is that in the case of an index value data 1400, the “index value” is not the “area of an area” but a “total value of the traffic amount”. Further, the total value of the traffic amount of each terminal located in the area having the line-of-sight relationship calculated by the base station position attitude control unit 1210 based on the combination of the corresponding position attitude parameters of “position” and “attitude” is stored to the “total value of the traffic amount”.

In the example of FIG. 14, in the case of a combination of each position attitude parameter of x-coordinate=x₁, y-coordinate=y₁, z-coordinate=z₁, pan angle=p₁, tilt angle=c₁, and roll angle=r₁ shows that the total value of the traffic amount=TR₁ is calculated. In this way, the base station position attitude control unit 1210 calculates the total value of the traffic amounts of terminals located in the area having the line-of-sight relationship for combinations of predetermined position attitude parameters each time the shield map is generated.

### Functional Configuration of Base Station Position Attitude Control Unit

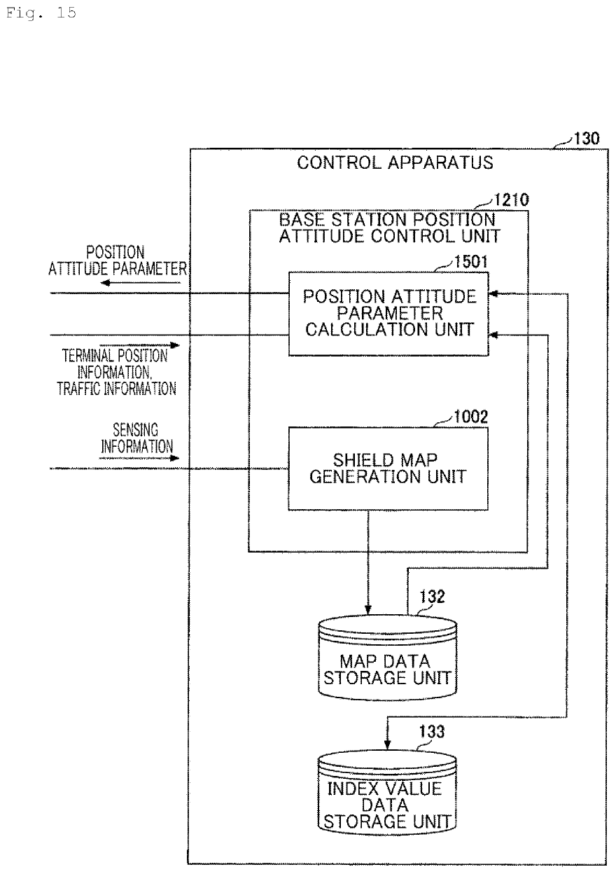

Next, details of the functional configuration of the base station position attitude control unit 1210 of a control apparatus 130 will be described with reference to FIGS. 13 and 14. FIG. 15 is a third diagram showing an example of the functional configuration of the base station position attitude control unit. Similar to the second embodiment, the base station position attitude control unit 1210 has a position attitude parameter calculation unit 1501 (an example of a calculation unit and a control unit) and a shield map generation unit 1002 (an example of a generation unit).

However, the position attitude parameter calculation unit 1501 specifies an area having the line-of-sight relationship for each predetermined position attitude parameter, and calculates a total value of traffic amounts of each terminal located in the specified area, and calculates the traffic information on the basis of the terminal position information, the traffic information, and the shield map. The shield map used by the position attitude parameter calculation unit 1501 for calculating the total value is, for example, two-dimensional map data 1310 shown in FIG. 13.

Further, the position attitude parameter calculation unit 1501 associates the calculated total value of the traffic amount with the position attitude parameter, and stores as index value data (for example, the index value data 1400 in FIG. 14) in the index value data storage unit 133. Further, the position attitude parameter calculation unit 1501 selects the position attitude parameter which becomes the maximum total value among the total values of traffic amounts for each position attitude parameter stored as index value data, and transmits it to the movable base station 110. Thus, the base station position attitude control unit 1210 can control the position and attitude of the base station 111 of the movable base station 110 in accordance with the shield, the terminal position and the traffic volume.

### Flow of Base Station Position Attitude Control Process

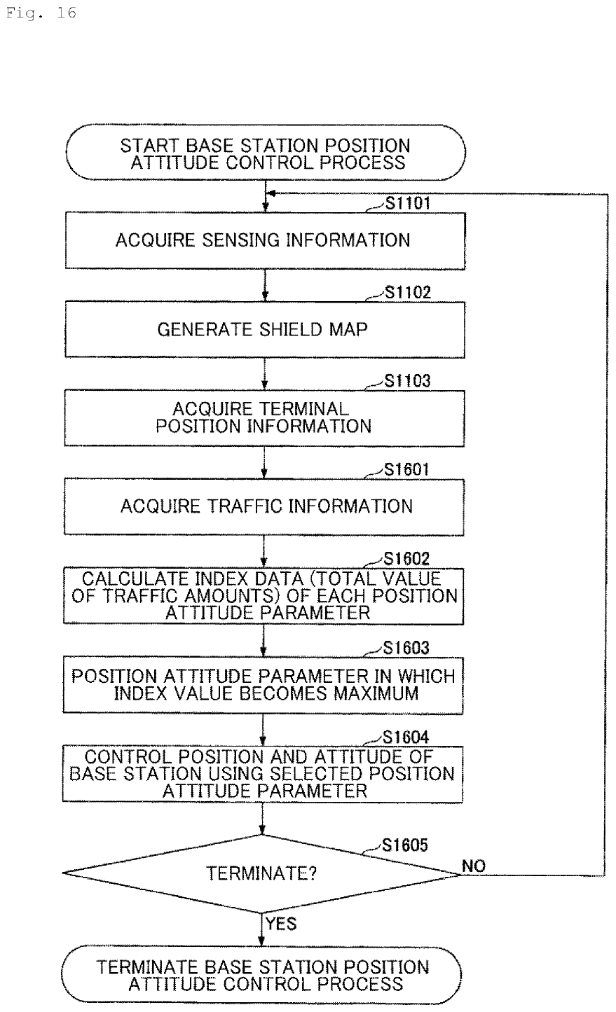

Next, the flow of base station position attitude control processing by the base station position attitude control unit 1210 of the control apparatus 130 will be described. FIG. 16 is a third flowchart showing the flow of the base station position attitude control process.

Of these, the processes shown in steps 31101 to 31103 are the same as the processes shown in steps 31101 to 31103 of FIG. 11, and thus the description thereof will be omitted here.
In step S1601, the position attitude parameter calculation unit 1501 acquires each traffic amount of the terminals 701 to 703 from the movable base station 110 as traffic information.
In step S1602, the position attitude parameter calculation unit 1501 calculates the total value of traffic amounts of each terminal located in the area having the line-of-sight relationship based on the shield map, the terminal position information, and the traffic information for each combination of the position attitude parameters. Further, the position attitude parameter calculation unit 1501 stores the calculated total value in an index value data storage unit 133 as index value data.
In step S1603, a position attitude parameter calculation unit 1501 selects a combination of position attitude parameters in which a total value of traffic amounts of each terminal located in the area having the line-of-sight relationship becomes maximum from among combinations of the position attitude parameters.
In step S1604, the position attitude parameter calculation unit 1501 controls the position and attitude of the base station 111 by transmitting the combination of the selected position attitude parameters to the movable base station 110.
In step S1605, a position attitude parameter calculation unit 1501 determines whether or not base station position attitude control process is terminated. If it is determined in step S1605 that the base station position attitude control process is to be continued (NO in step S1605), the process returns to step S1101. Thus, the position attitude parameter calculation unit 1501 can control the position and the attitude of the base station 111 at every predetermined period.
On the other hand, if it is determined in step S1605 that the base station position attitude control process is terminated (YES in step S1605), the base station position attitude control process is terminated.

### Summary

As is clear from the above description, the control system 1200 according to the third embodiment;
includes the base station and the control device for controlling the base station,
for each combination of parameters that determine the transmission point and transmission direction of the radio wave of the base station, specifies the area having the line-of-sight relationship (area not shielded by the shield) in the communication area of the base station, calculates the total traffic amount of each terminal (index value) located it in the specified area,
controls the transmission point and transmission direction of the radio wave of the base station by using the combination of parameters that maximizes the calculated the total value.

Thus, the control system 1200 according to the third embodiment can form a communication area corresponding to the shield, the terminal position, and the traffic amount. As a result, according to the third embodiment, for example, the off-load effect can be maximized.

### Other Embodiments

In the above-described second and third embodiments, the case where the shield map is generated by using the sensing information transmitted from a shield detecting device 120 and terminals 701 to 703, but the shield map may be generated by using the sensing information transmitted from either one of them.

In each of the above embodiments, the from the x-coordinate to the roll angle of a base station 111 is exemplified as the position attitude parameter, but the position attitude parameter is not limited to this, other parameters may be used as long as the parameters represent the position and the attitude.

In each of the above embodiments, as the index values, an area of an area having a line-of-sight relationship, the number of terminals located in the area having the line-of-sight relationship, A total value of traffic amounts of each terminal located in the area having the line-of-sight relationship is exemplified. However, the index value is not limited to these, and other index values may be used as long as the index value is related to the area in the line-of-sight relationship.

Further, in each of the above embodiments, a control apparatus 130 has been described as being disposed in the vicinity of a movable base station 110 and the shield detection device 120, The shield detection device may be disposed at a position away from the movable base station 110 and the shield detection device. A part of the functions realized by the control apparatus 130 may be realized by the movable base station 110 or the shield detecting device 120. Alternatively, a part of the functions realized by the movable base station 110 or the shield detector 120 may be realized by the controller 130.

Note that the present invention is not limited to the structure described here, such as a combination with other elements, in the structure described above. These points can be changed without departing from the spirit of the present invention, and can be appropriately determined according to the application form thereof.

### REFERENCE SIGNS LIST

100, 700, 1200 Control system
110 Movable base station
111 Case station
120 Shield detection device
130 Control apparatus
131, 710, 1210 Base station position attitude control unit
210, 1310 Map data
220, 1320 Shield
300, 900, 1400 Index value data
501, 1001, 1501 Position attitude parameter calculation unit
502, 1002 Shield map generation unit
701, 702, 703 Terminal

1. A control system including a base station and a control apparatus for controlling the base station, the control apparatus comprising:
a processor; and
a memory that includes instructions, which when executed, cause the processor to
identify an area having a line-of-sight relationship in a communication area of the base station for each parameter for determining a transmission point and a transmission direction of a radio wave transmitted from the base station, and calculate an index value regarding the identified area; and
control a transmission point and a transmission direction of a radio wave transmitted from the base station by using a parameter in which the index value becomes maximum.

2. The control system according to claim 1, wherein the instructions, which when executed, cause the processor to calculate a size of an area having a line-of-sight relationship in a communication area of the base station as the index value related to the area having the line-of-sight relationship.

3. The control system according to claim 1, wherein the instructions, which when executed, cause the processor to calculate one of the number of terminals located in the area having the line-of-sight relationship in the communication area of the base station or a total value of traffic amounts of each terminal located in the area having the line-of-sight relationship in the communication area of the base station, as the index value related to the area having the line-of-sight relationship.

4. The control system according to claim 2, wherein the instructions, which when executed, cause the processor to generate a shield map indicating a position and a size of a shield in the communication area of the base station, and to calculate the index value based on the shield map.

5. The control system according to claim 3, wherein the instructions, which when executed, cause the processor to generate a shield map indicating a position and a size of a shield in the communication area of the base station, and
calculate the index value based on the shield map and location information of each terminal, or based on the shield map, the location information of each terminal, and traffic information of each terminal.

6. A control method executed by a control apparatus, the control method comprising:
identifying an area having a line-of-sight relationship in a communication area of a base station for each parameter for determining a transmission point and a transmission direction of a radio wave transmitted from the base station, and calculating an index value regarding the identified area; and
controlling the transmission point and the transmission direction of the radio wave transmitted from the base station by using the parameter in which the index value becomes maximum.

7. A control apparatus, comprising:
a processor; and
a memory that includes instructions, which when executed, cause the processor to
identify an area having a line-of-sight relationship in a communication area of a base station for each parameter for determining a transmission point and a transmission direction of a radio wave transmitted from the base station, and calculate an index value regarding the identified area; and
control the transmission point and the transmission direction of the radio wave transmitted from the base station by using the parameter in which the index value becomes maximum.

8. A non-transitory computer readable storage medium storing a control program, which when executed, causes a computer to function as the control apparatus according to claim 7.
